(19) United States
(12) Patent Application Publication
(10) Pub. No.: US 2004/0213255 A1
(43) Pub. Date: Oct. 28, 2004

(54) Connection shaping control technique implemented over a data network

(75) Inventors: Kenneth W. Brinkerhoff, Mission Viejo, CA (US); Wayne P. Boese, Costa Mesa, CA (US); Robert C. Hutchins, Mission Viejo, CA (US); Stanley Wong, Santa Ana, CA (US)

Correspondence Address: BEYER WEAVER & THOMAS LLP, P.O. BOX 778, BERKELEY, CA, 94704-0778, US

(73) Assignee: Mariner Networks, Inc

(21) Appl. No.: 09/896,031

(22) Filed: Jun. 28, 2001

Related U.S. Application Data
(60) Provisional application No. 60/215,558, filed on Jun. 30, 2000.

(51) Int. Cl. H04J 3/18

(52) U.S. Cl. 370/395.1; 370/477; 370/468

(57) ABSTRACT

A improved connection shaping technique is disclosed, whereby at least one high-priority “preemptive” service flow is initiated at a customer entity in order to limit or restrict the effective usable bandwidth on a particular line or connection. According to at least one embodiment, a preempt data parcel corresponds to a data parcel which includes non-meaningful data. When the preempt cells are received at the ingress port of the communication line, the preempt cells may be identified as non-meaningful data parcels, and may be discarded in accordance with conventional protocols.

### RELATED APPLICATION DATA

The present application claims priority under 35 USC 119(e) from U.S. Provisional Patent Application No. 60/215,558 (Attorney Docket No. MO15-1001-Prov) entitled “INTEGRATED ACCESS DEVICE FOR ASYNCHRONOUS TRANSFER MODE (ATM) COMMUNICATIONS”; filed Jun. 30, 2000, and naming Brinkerhoff, et. al., as inventors (attached hereto as Appendix A); the entirety of which is incorporated herein by reference for all purposes.

The present application is also related to U.S. patent application Ser. No. ______ (Attorney Docket No. MRNRP004), entitled “TECHNIQUE FOR IMPLEMENTING FRACTIONAL INTERVAL TIMES FOR FINE GRANULARITY BANDWIDTH ALLOCATION”, naming Brinkerhoff, et. al., as inventors, and filed concurrently herewith; the entirety of which is incorporated herein by reference for all purposes.

### BACKGROUND OF THE INVENTION

1. Field of the Invention

The present invention relates generally to data networks, and more specifically to a technique for implementing connection shaping control at the customer or end user portion of a data network.

2. Description of the Related Arts

Conventionally, customer entities desiring access to high bandwidth communication lease their high bandwidth connections from one or more service providers. Such leased connections are typically implemented in accordance with a Service Level Agreement (SLA) between the service provider and the customer entity, whereby, for a predetermined fee to be paid by the customer entity, the service provider agrees to provide a guaranteed amount of bandwidth on the leased line to the customer entity.

FIG. 1A shows a simplified data network 100 which includes a leased communication line 105 which connects customer entity 102 to the service provider network 104. Line 105 may be implemented using a variety of different communication protocols such as, for example, frame relay, ATM, Ethernet, etc. It will be appreciated that the service provider 104 may service the needs of different customers using a variety of different links in the data network. Each link (e.g. 105) is configured to handle a respective predetermined maximum or peak amount of bandwidth at any one time. This peak bandwidth value is typically referred to as the line rate. For example, line 105 may be configured to have a line rate of 3.0 megabits per second (Mbps).

Typically, it is not uncommon for the customer entity 102 to lease only a portion of the available bandwidth on line 105. For example, in FIG. 1A, the SLA between the customer entity 102 and the service provider may specify that the service provider guarantees to provide a peak bandwidth of 1.0 Mbps to the customer entity 102 on line 105. This concept is illustrated in FIG. 1B.

FIG. 1B shows an example of different bandwidth allocations on line 105 of FIG. 1A. As shown in FIG. 1B, the line 105 has a total available bandwidth of BW1 (e.g. 3.0 Mbps). However, customer entity 102 wishes only to lease a portion of the available bandwidth on line 105. This portion of leased bandwidth is represented in FIG. 1B as the leased or usable bandwidth portion BW3 (e.g. 1.0 Mbps). According to the terms of the SLA, the service provider provides no guarantees to the customer entity for accommodating data flows in excess of the usable bandwidth portion BW3. Moreover, as explained in greater detail below, the service provider will typically drop any data transmitted by the customer on line 105 which exceeds the leased bandwidth rate of 1.0 Mbps. As a result, the “effective usable bandwidth” of line 105 (from the customer perspective) is limited to the usable bandwidth portion BW3. Thus, it will be appreciated that in circumstances where the customer has purchased or leased only a portion of the total available bandwidth on a particular connection, there arises a need for ensuring that the customer entity does not use bandwidth in excess of the customer's usable bandwidth portion.

Conventionally, there are a variety of different techniques which may be used to limit the effective usable bandwidth of a leased line or other connection which may be used by a customer such as, for example, policing and port shaping. Generally, port shaping techniques involve controlling the bit stream at the egress port at the customer entity end, whereas policing techniques involve throwing away unwanted input at the ingress port at the service provider end.

More specifically, conventional policing techniques involve the service provider policing the bandwidth usage on the communication line by the customer entity in order to enforce the provisions of the SLA. In policing, the ingress port at the service provider end is monitored for bandwidth usage of a given customer, and data transmitted by the customer over a specified bandwidth may be dropped or discarded. For example, in a specific embodiment where the line 105 corresponds a leased ATM connection, the service provider may monitor ATM cells from the customer entity 102 which are received at the ingress port at the service provider end 104 (connected to line 105), and may discard or drop cells from the customer entity which exceed the permitted usable bandwidth for that customer.

The policing technique has the effect of restricting data or other information flowing to the service provider, but may have a severe negative impact on the service as perceived by the customer entity 102. For example, data applications may become extremely slow, even with slight data loss (i.e. discarded cells). Moreover, the discarding of even a small percentage of cells renders the network service unusable for many applications, including data, voice, video, etc.

Another technique which may be used to limit the effective usable bandwidth for a particular link is referred to as port shaping or connection shaping (herein referred to as connection shaping). In connection shaping, the bit stream at the egress port at the customer entity end is controlled in order to ensure that the peak bandwidth used by the customer entity does not exceed a specified bandwidth. Typically, port shaping is implemented by adding additional hardware at the customer entity in order to clock outgoing cells from a particular port at a lower rate than the line rate of the line connected to that port. In this way, connection shaping has the effect of throttling the effective output of a port to a rate (e.g. 2 Mbps) which is lower than that of the line rate (e.g. 3 Mbps). However, it will be appreciated that connection shaping implementation adds significant cost and overhead to conventional scheduling systems since it involves the addition of synchronous time features to switching functions which would otherwise only be concerned with cell sequencing.

Additionally, when implementing connection shaping, one must be careful to add up the QoS guaranteed rates and peak rates for each of the flows to be transmitted by the customer entity. Generally, most different types of QoS service (e.g. CBR, VBR, UBR+, etc.) include a guaranteed portion of service and a best effort portion of service. While it is possible to limit the effective usable bandwidth available to each of the guaranteed portions of service, it is more difficult to limit the effective usable bandwidth for each of the best effort portions of service to ensure that the total bandwidth used by the best effort services does not exceed a predetermined bandwidth.

For example, according to conventional techniques, UBR and VBR service is typically handled by allowing UBR and VBR service flows to utilize as much bandwidth as is available on the communication line. If more than one type of service requires simultaneous use of the communication, the available bandwidth is allocated equally or proportionally to each of the requesting service flows. However, where the available bandwidth of a communication line is greater than the maximum peak bandwidth leased by the customer, then it is possible for the customer to use more bandwidth than that which has been allocated to that customer. When this occurs, the data associated with the excess bandwidth used by the customer will be dropped at the service provider end. As a result, one or more of the customer service flows may die due to the fact that a portion of their data has been dropped by the service provider. Moreover, it will be appreciated that there are currently no mechanisms for dynamically allocating bandwidth resources based upon a given number of best effort clients sharing a particular connection.

Accordingly, it will be appreciated that there exists a general desire to improved upon connection shaping techniques implemented in data networks.

### SUMMARY OF THE INVENTION

According to different embodiments of the present invention, a improved connection shaping technique is provided, whereby at least one high-priority “preemptive” service flow is initiated at the customer entity in order to limit or restrict the effective usable bandwidth on a particular line or connection. According to at least one embodiment, a preempt data parcel corresponds to a data parcel which includes non-meaningful data. In one implementation, each preempt data parcel is treated as a valid high-priority data parcel at the transmitting entity, but is treated as a disposable or non-meaningful data parcel (e.g. a data parcel which may be immediately disposed of) at the receiving end of the communication line.

Each preempt flow may be used to reduce the effective usable bandwidth which is available on a particular communication line to be used by a customer entity. When the preempt cells are received at the ingress port of the communication line, the preempt cells may be identified as non-meaningful data parcels, and may be discarded in accordance with conventional protocols.

According to specific embodiments of the present invention, the preempt data parcels are configured to conform with a variety of different communication protocol formats which define non-meaningful data parcels that may be disposed of or thrown out at the receiving end of a communication line. For example, in one embodiment, the preempt data parcels may be implemented as “filler” frames containing specific patterns of flag bytes which are used to indicate that a particular portion of continuous bits (forming a frame) does not contain meaningful data, and may therefore be thrown out at the receiving end of the frame relay connection, in accordance with the standardized frame relay communication protocol. Alternatively, in a different embodiment, the preempt data parcels may be implemented as idle ATM cells, which may be thrown out or discarded at the receiving end of the ATM connection, in accordance with the standardized ATM communication protocol.

Alternate embodiments of the present invention are directed to methods, computer program products, and systems for controlling bandwidth resources used on a communication line in a data network. A first end of the communication line is connected to a first entity, and a second end of the communication line is connected to a second entity. A first desired portion of bandwidth on the communication line to be prevented from being used by the first entity for transmitting data parcels which include meaningful data is determined. Preempt data parcels are transmitted over the communication line to thereby cause the first desired portion of bandwidth on the communication line to be prevented from being used by the first entity for transmitting data parcels which include meaningful data. According to a specific embodiment, the preempt data parcels correspond to disposable data parcels which include non-meaningful data.

According to a specific implementation, the preempt data parcels may be scheduled by a scheduler to be included in an output stream provided to physical layer logic for transmission over the first communication line to thereby limit an effective usable bandwidth on the communication line to be used by the first entity for transmitting data parcels which include meaningful data.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1A shows a simplified data network 100 which includes a leased communication line 105 which connects customer entity 102 to the service provider network 104.

FIG. 1B shows an example of different bandwidth allocations on line 105 of FIG. 1A.

FIG. 2 shows a block diagram of a specific embodiment of a portion of a data network which may be used for implementing the connection shaping technique of the present invention.

FIGS. 3A-C illustrate different embodiments of componentry and/or logic which may be used for implementing the connection shaping technique of the present invention.

FIG. 4A shows a flow diagram of a Preemptive Bandwidth Procedure A 400 in accordance with a specific embodiment of the present invention.

FIG. 4B shows an alternate embodiment of a preemptive bandwidth procedure 470 which may be implemented in conjunction with conventional scheduling techniques.

FIG. 5 shows an example of a Client Flow Table 500 in accordance with a specific embodiment of the present invention.

FIG. 6A shows an example of a Client Cell Interval Table 650 which may be used for implementing the connection shaping technique of the present invention.

FIG. 7 shows a specific embodiment of a network device 60 suitable for implementing various techniques of the present invention.

FIG. 8 shows a block diagram of various inputs/outputs, components and connections of a system 800 which may be used for implementing various aspects of the present invention.

### DETAILED DESCRIPTION OF THE PREFERRED EMBODIMENTS

Many conventional communication protocols such as, for example, frame relay and ATM, require that a continuous stream of bits be continuously transmitted between endpoints of a communication link. For such protocols, a variety of mechanisms exist for enabling the end point receiving the continuous bit stream to differentiate between data parcels (e.g. frames, cells, etc.) which contain meaningful data, and data parcels which do not contain meaningful data, but rather are transmitted by the transmitting end merely to satisfy the continuous bit stream requirement.

For example, in frame relay networks, as described, for example, in the Frame Relay Forum (FRF) Reference Document FRF. 1.2, July, 2000, specific patterns of flag bytes are used to indicate that a particular portion of continuous bits (forming a frame) corresponds to a “filler” frame which does not contain meaningful data, and was transmitted by the transmitting end of the connection merely to satisfy the continuous bit stream requirement of the frame relay protocol. When a “filler” frame is identified at the receiving end of the connection, it is typically dropped or thrown out by the physical layer logic.

Similarly, in ATM networks, such as that described, for example, in the ATM reference document entitled, “A Cell-based Transmission Convergence Sublayer for Clear Channel Interfaces”, af-phy-0043.000, November 1995, cells which contain meaningful data are referred to as data cells, and cells which do not contain meaningful data are referred to as idle cells. Each type of ATM cell may be identified by referencing information contained in the header portion of the ATM cell. Conventionally, idle cells are transmitted during idle periods (e.g. when there is no data to transmit) in order to satisfy the continuous bit stream requirement of the ATM protocol. When an idle cell is received at the receiving end of the connection, it is typically dropped or thrown out by the physical layer logic.

According to different embodiments of the present invention, a improved connection shaping technique is provided, whereby at least one high-priority “preemptive” service flow is initiated at the customer entity in order to limit or restrict the effective usable bandwidth on a particular line or connection. According to at least one embodiment, a preempt data parcel corresponds to a data parcel which includes non-meaningful data. In one implementation, each preempt data parcel is treated as a valid high-priority data parcel at the transmitting entity, but is treated as a disposable or non-meaningful data parcel (e.g. a data parcel which may be immediately disposed of) at the receiving end of the communication line.

Each preempt flow may be used to reduce the effective usable bandwidth which is available on a particular communication line to be used by a customer entity. When the preempt cells are received at the ingress port of the communication line, the preempt cells may be identified as non-meaningful data parcels, and may be discarded in accordance with conventional protocols. Since the preemptive data parcels are typically discarded at the physical layer of the ingress port, the discarded data parcels will typically not be counted by the service provider as part of the customer's bandwidth usage.

According to specific embodiments of the present invention, the preempt data parcels are configured to conform with a variety of different communication protocol formats which define non-meaningful data parcels that may be disposed of or thrown out at the receiving end of a communication line. For example, in one embodiment, the preempt data parcels may be implemented as “filler” frames containing specific patterns of flag bytes which are used to indicate that a particular portion of continuous bits (forming a frame) does not contain meaningful data, and may therefore be thrown out at the receiving end of the frame relay connection, in accordance with the standardized frame relay communication protocol. Alternatively, in a different embodiment, the preempt data parcels may be implemented as idle ATM cells, which may be thrown out or discarded at the receiving end of the ATM connection, in accordance with the standardized ATM communication protocol.

In a specific embodiment, the preempt data parcels may be generated by a scheduler or other logic residing at the customer entity. For purposes of QoS scheduling, the “preempt” data parcels are treated by the scheduler and other components at the customer entity as high-priority data parcels which include meaningful data. In at least one implementation, a plurality of preempt CBR flows having different associated bit rates may be implemented at the customer entity. According to a specific implementation, each preemptive flow may be configured to generate a continuous stream of “preempt” data parcels to be transmitted by the client entity's output transmitter logic over the communication line.

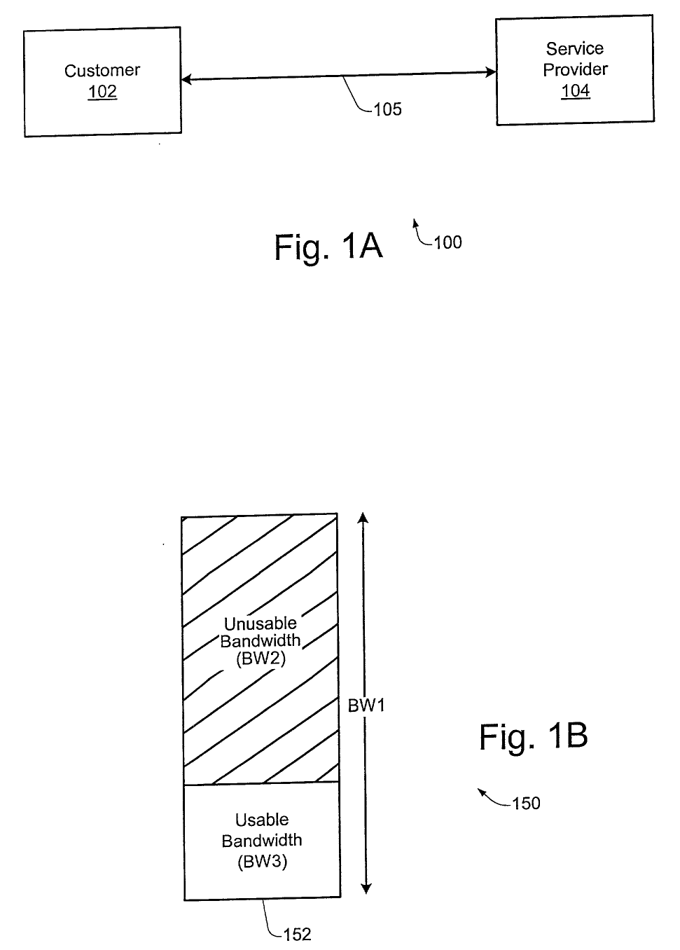

For purposes of illustration, the following example is used to illustrate how the technique of the present invention may be used to limit the amount of effective usable bandwidth on the communication line 105 of FIG. 1A. In this example, it is assumed that the communication line 105 is capable of providing a peak bandwidth of 3.0 Mbps, and that the customer 102 has leased 1.7 Mbps of bandwidth on line 105. Additionally, it is assumed that a portion of the customer's leased bandwidth is to be used for best-effort traffic.

In the present example, the customer entity 102 wishes to implement connection shaping at its end in order to limit the effective usable bandwidth of line 105 to 1.7 Mbps. In accordance with the technique of the present invention, the customer is able to achieve connection shaping at the egress port to line 105 by implementing one or more preempt flows. For example, a single high priority preempt flow may be implemented at the customer entity 102 which is configured to generate and transmit preempt data parcels over line 105 at an effective bit rate of 1.3 Mbps. Alternatively, for finer granularity of bandwidth control, multiple high priority preempt flows may be implemented at the customer entity 102 which collectively preempt 1.3 Mbps of bandwidth on line 105. For example, a first preempt CBR flow may be implemented to transmit preempt data parcels on line 105 at an effective bit rate of 1.0 Mbps, and a second preempt CBR flow may be implemented to transmit preempt data parcels on line 105 at an effective bit rate of 0.3 Mbps. As a result, 1.3 Mbps of bandwidth on line 105 will be used for carrying preempt data parcels, while the remaining 1.7 Mbps of bandwidth is available to be used by the other client or process flows associated with customer entity 102. Accordingly, the effective usable bandwidth for guaranteed and/or best effort traffic generated by customer entity 102 on line 105 will be limited to 1.7 Mbps. Moreover, since the preempt data parcels have been configured to resemble non-meaningful data parcels in accordance with standardized protocol, it will appear, from the perspective of the service provider, that the customer entity 102 is using only up to 1.7 Mbps of bandwidth on line 105.

It will be appreciated that the technique of the present invention may be used to dynamically allocate bandwidth resources based upon any number of best effort and/or guaranteed service flows associated with customer entity 102. For example, referring to FIG. 1A, let us assume that the service provider 104 has agreed to provide customer entity 102 with 1.5 Mbps of bandwidth during peak hours, and 2.0 Mbps of bandwidth during non-peak hours. Further, it is assumed that the peak bandwidth capacity on line 105 is 3.0 Mbps. In this example, a plurality of preempt client flows may be set up at the customer entity 102 for dynamically preempting bandwidth on line 105 during peak and non-peak hours. For example, a first preempt client flow may be established to preempt 1.0 Mbps of bandwidth from line 105, which may be active at all times. Additionally, a second preempt client flow may be implemented to preempt 0.5 Mbps of bandwidth on line 105. This second preempt client flow may be configured to be active during peak hours, and non-active during non-peak hours. As a result, the effective usable bandwidth on line 105 will be 1.5 Mbps during peak hours, and 2.0 Mbps during non-peak hours. Additionally, as explained in greater detail below, the connection shaping technique of the present invention may be used to limit the effective usable bandwidth on a particular communication line for both guaranteed and best effort service flows.

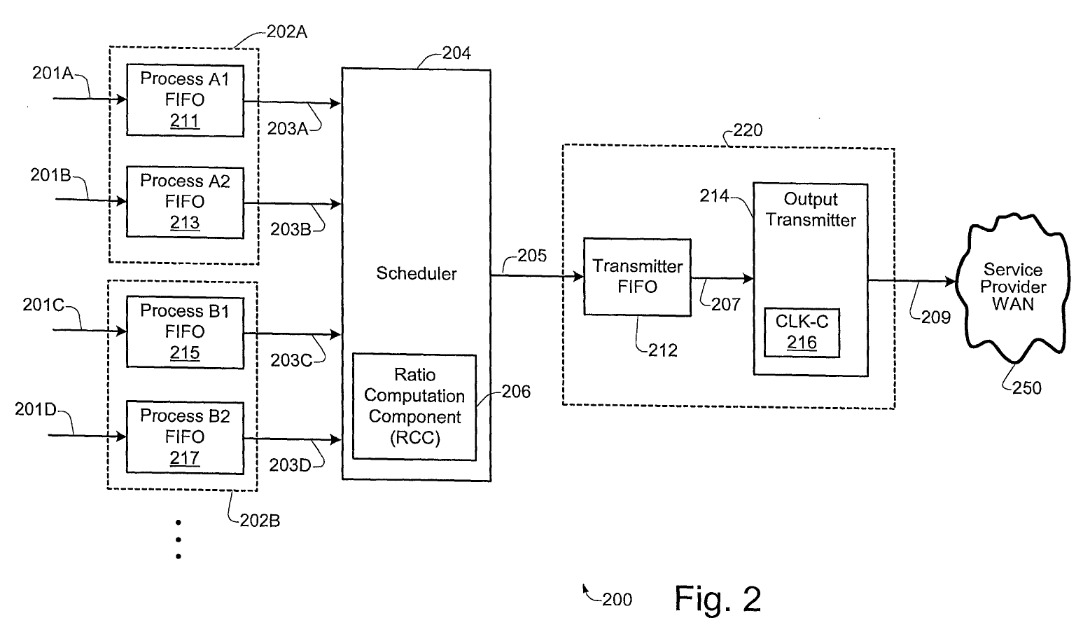

FIG. 2 shows a block diagram of a specific embodiment of a portion of a data network which may be used for implementing the connection shaping technique of the present invention. The embodiment of FIG. 2 is described in greater detail in U.S. patent application Ser. No. ______, entitled “TECHNIQUE FOR IMPLEMENTING FRACTIONAL INTERVAL TIMES FOR FINE GRANULARITY BANDWIDTH ALLOCATION” (previously incorporated herein by reference in its entirety for all purposes). As shown in the embodiment of FIG. 2, a scheduler 204 is configured to service a plurality of different client processes which may have different associated line rates. The client processes store their output data cells in output buffers 202A, 202B. The scheduler 204 includes a ratio computation component (RCC) 206 which may be configured to perform functions for determining an appropriate ratio of idle cells to be inserted into the output data stream 205 in order to achieve a desired timing relationship of data/idle cells which may then be passed to the output transceiver circuitry 220 for transmission over line 209.

Using the functionality of the ratio computation component 206, the scheduler 204 may generate an output data stream on line 205. According to specific implementation, the scheduler 204 may be configured to have an output rate which is sufficiently fast enough to ensure that the output transceiver buffer 212 is never empty. In this way, the physical layer (e.g. transmitter componentry 220) may be prevented from generating and inserting idle cells into the output data stream. In one implementation, the output data stream on line 205 preferably has an effective line rate equal to that of line 209. Additionally, according to specific implementations of the present invention, the output data stream on line 205 may include not only data cells from each of the client processes 201A-D, but may also include an appropriate number or ratio of idle cells which have been inserted into the output data stream 205 to thereby cause line 205 to have an effective line rate equal to that of line 209.

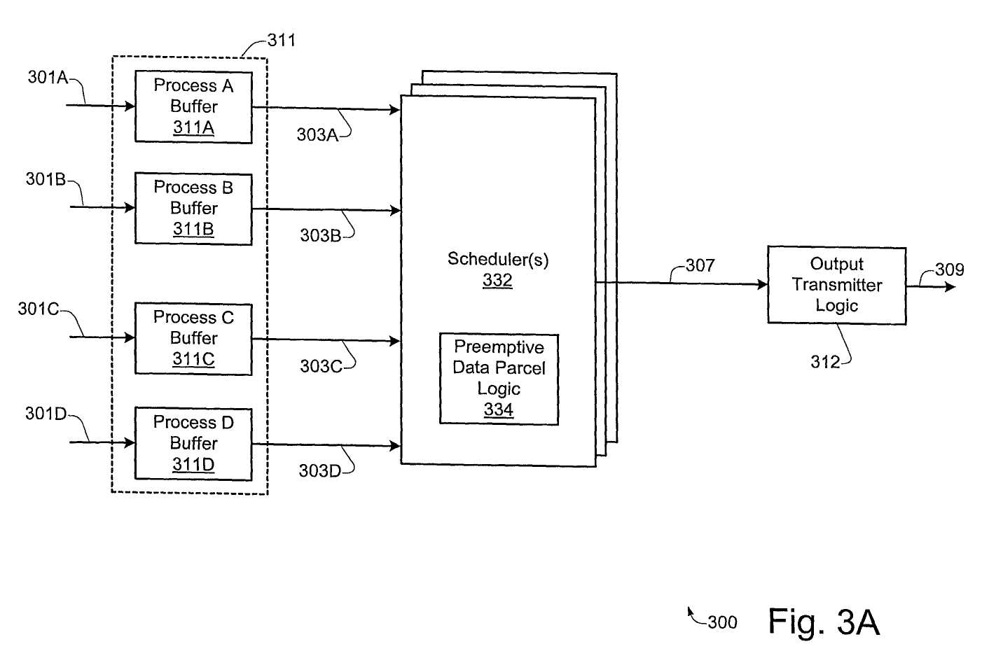

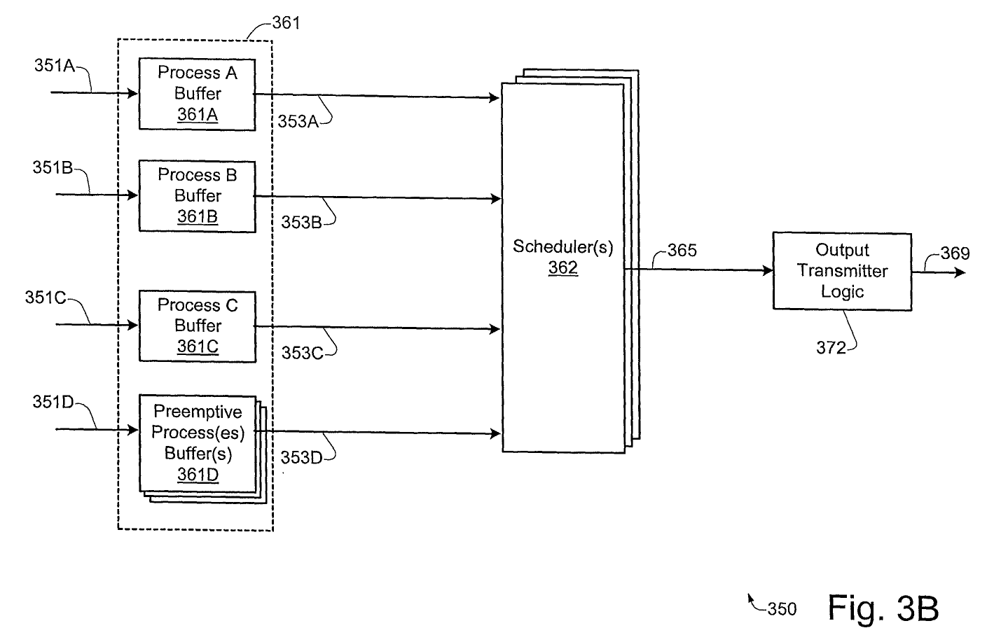

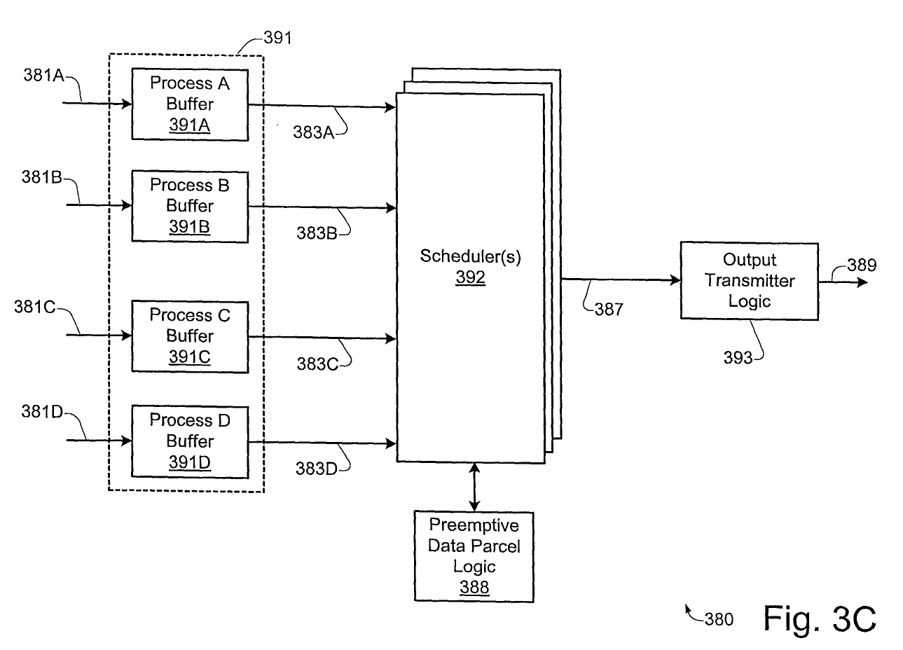

FIGS. 3A-C illustrate different embodiments of componentry and/or logic which may be used for implementing the connection shaping technique of the present invention. According to various embodiments, at least a portion of the components shown in FIGS. 3A-C may reside at the customer entity 102 of FIG. 1A.

As shown in the embodiment of FIG. 3A, one or more schedulers 332 may be used to service a plurality of different client or process flows. For purposes of illustration, and in order to avoid confusion, it will be assumed that each of the client flows or processes has been implemented in accordance with a standardized ATM communication protocol. However, as described in greater detail below, the technique of the present invention may be modified by one having ordinary skill in the art to be used in a variety of different systems employing a variety of different communication protocols.

In the embodiment of FIG. 3A, one or more schedulers 332 may be configured to include preemptive data parcel logic 334, which may be used for implementing the connection shaping control technique of the present invention. Alternatively, as shown in FIG. 3C, one or more schedulers 392 may be configured to communicate with preemptive data parcel logic 388 for implementing the connection shaping control technique of the present invention.

FIG. 3B shows an alternate embodiment of a scheduler configuration which may be used for implementing the connection shaping technique of the present invention. In the example of FIG. 3B, one or more preempt client flows 351D maybe implemented at the customer entity. The preempt data parcels which are generated by the preempt client flows are queued in a plurality of preemptive process buffers 361D. According to a specific embodiment, the scheduler 362 may service data parcels from the preemptive process buffers in the same manner that it services data parcels from the other client process buffers (e.g., 361A-C), with the exception that the preempt data parcels queued in the preemptive process buffers have the highest scheduling priority.

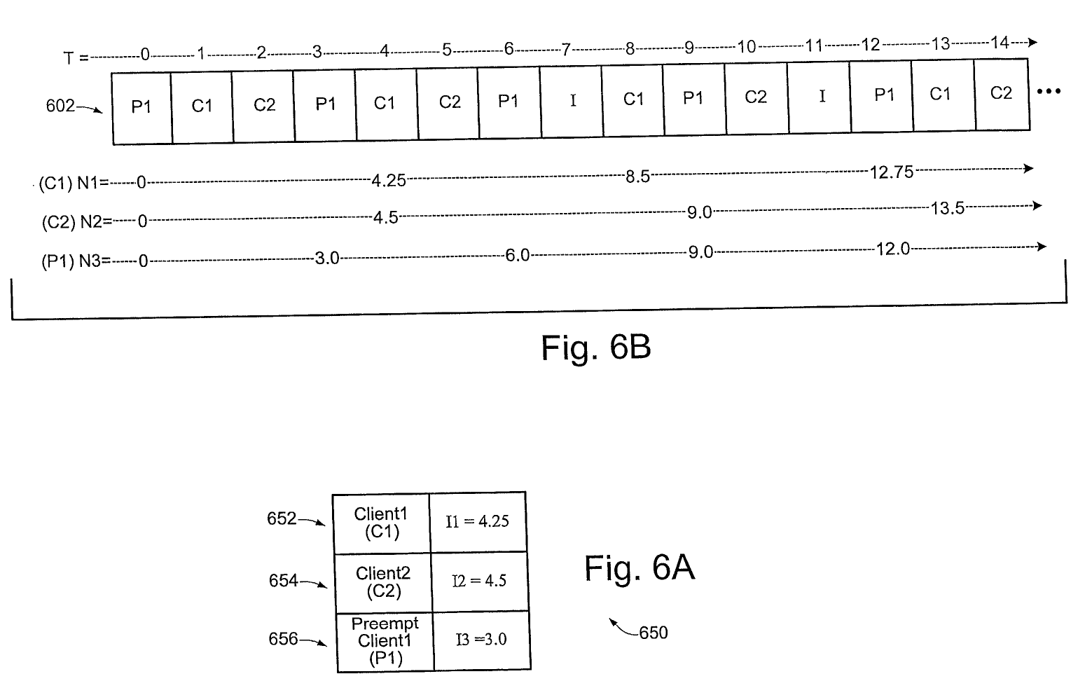

FIG. 6A shows an example of a Client Cell Interval Table 650 which may be used for implementing the connection shaping technique of the present invention. In the example of FIG. 6A, it is assumed that two different client processes, namely Client 1 (C1) and Client 2 (C2) are each generating output data which is to be transmitted by the output transmitter logic 312 (FIG. 3A) over line 309. Additionally, it is also assumed that a preempt client process, namely Preempt Client 1 (P1), has been implemented at the customer entity, and is generating preempt data parcels (e.g. preempt idle cells) to be transmitted by the output transmitter logic 312 over line 309.

As shown in Table 650, each process or flow may have an associated cell interval (Iᵢ) value which represents how often a data parcel from a particular flow is to be transmitted over line 309. According to a specific implementation, the cell interval value may be defined as an integer, a fixed point integer, a floating point number, a floating point number, etc. For example, in the example of FIG. 6A, client flow C1 has an associated interval value of I1=4.25, meaning that a new data cell from client flow C1 is to be scheduled once every 4.25 ATM cells which are transmitted over line 309. Client flow C2 has an associated interval value of I2=4.5, meaning that a new data cell from client flow C2 is to be scheduled once every 4.5 ATM cells which are transmitted over line 309. Similarly, preempt client P1 (which, according to a specific embodiment, may be treated as a high-priority flow for scheduling purposes) has an associated interval value of I3=3.0, meaning that a new preempt idle cell from preempt client P1 is to be scheduled once every 3 ATM cells which are transmitted over line 309. According to a specific embodiment, the preempt cells are treated the same as client data cells for purposes of QoS scheduling.

According to different embodiments, computation of the cell interval value for selected client flows may be determined based upon several factors such as, for example, QoS, line rate of the client flow (sometime referred to as the client flow bit rate), line rate of the service provider (herein referred to as the “output line rate”), etc. For example, if the line which services client flow C1 (e.g. line 351A, FIG. 3A) has an associated line rate of 1.5 Mbps, and the line rate of the service provider line 309 is 3.0 Mbps, then the cell interval value for client flow C1 may be calculated according to: 3 Mbps/1.5 Mbps=2, which means that client flow C1 has the potential to transmit a data cell for every two ATM cells which are transmitted over line 309. Similarly, if the line rate a line servicing client flow C2 is equal to 1.0 Mbps, then the cell interval value for client C2 would be equal to 3 Mbps/1 Mbps=3, meaning that client flow C2 has the potential to transmit a data cell for every three ATM cells which are transmitted over line 309. It will be appreciated that the cell interval value for any selected flow may also be adjusted based upon the QoS parameters.

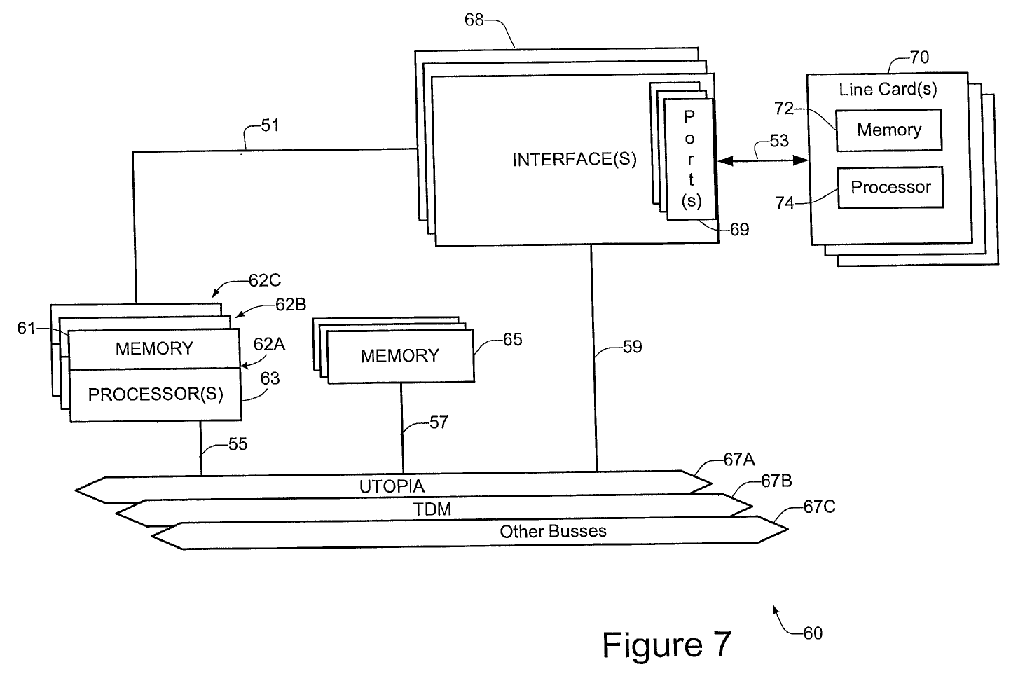

According to different embodiments of the present invention, the cell interval value for each flow may either be statically or dynamically determined. According to a specific implementation, as shown, for example, in FIG. 7, calculation of the cell interval values for each flow may be implemented by a processor such as processor 62A or 62B.

According to a specific embodiment, when a given line card is electrically coupled to the system 60 of FIG. 7, the respective line rates of the ports residing on that line card may be stored in line card memory 72. This data may then be accessed by a processor such as 62A or 62B, which uses the port line rate information to calculate a respective cell interval value for each port. The cell interval values may then be stored locally in memory such as, for example, in CPU memory 61 or in system memory 65. Since data from each client flow is associated with a respective port, the cell interval value associated with a particular client flow may be equal to the cell interval rate for the associated port, adjusted by any QoS parameter(s) associated with that client flow (if desired). Once the cell interval value for a specific client flow has been determined, that value may be stored in Table 650, which may reside, for example, in processor memory or system memory (FIG. 7).

The computation of cell interval values for selected preempt client flows may be calculated somewhat differently. According to a specific embodiment, the cell interval value for a selected preempt client flow may be assigned a value which is related to a desired amount of bandwidth to be preempted on line 309 (FIG. 3). For example, if the line rate of line 309 is 3.0 Mbps, and it is desired to preempt 2.0 Mbps of bandwidth from the line (thereby leaving an effective usable bandwidth of 1.0 Mbps), then the cell interval value for the preempt client flow may be calculated according to: 3 Mbps/2 Mbps=1.5, meaning that a new preempt cell will be scheduled for transmission over line 309 for every 1.5 ATM cells which are transmitted over line 369.

According to alternate embodiments, a plurality of preempt client flows may be implemented at the customer entity in order to achieve finer granularity across the entire bandwidth range. Moreover, each of the different preempt client flows may have a different associated cell interval value. For example, a first preempt client may be configured at the client entity to preempt 1.0 Mbps of bandwidth on line 309, and a second preempt client may be configured at the client entity to preempt 0.5 Mbps of bandwidth on line 309. The use of multiple preempt client flows not only may be used to provide finer granularity of preempted bandwidth on line 309, but may also provide an additional advantage of enabling dynamic allocation of bandwidth resources on line 309. For example, each preempt client may be dynamically enabled or disabled in order to dynamically adjust the amount of preempted bandwidth on line 309 at any given time.

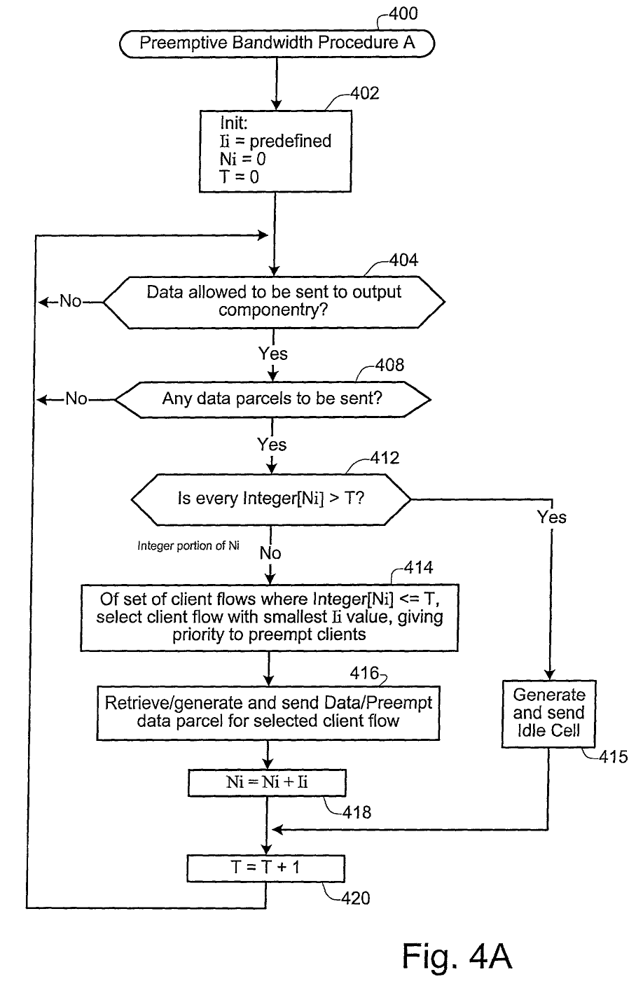

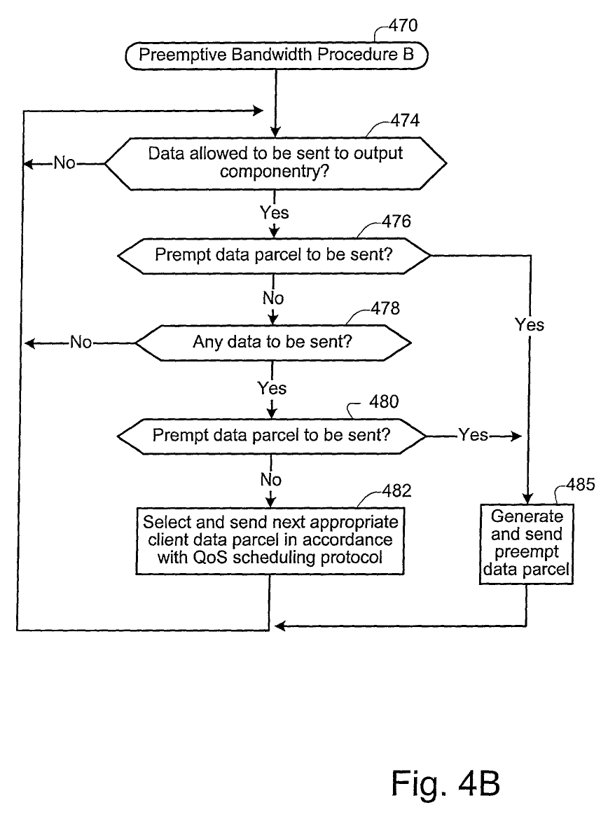

In the example of FIG. 6A, it is assumed that the client flow C1 has a cell interval value I1=4.25, client flow C2 has a cell interval value I2=4.5, and preempt client P1 has a cell interval value I3=3.0. Using the example of FIG. 6A, the Preemptive Bandwidth Procedure 400 of FIG. 4A will now be described in order to derive the output stream 602 illustrated in FIG. 6B, which, according to a specific implementation, illustrates an output stream transmitted by the scheduler(s) 332 on line 307 of FIG. 3A. According to a specific implementation, this output stream is identical to the output stream transmitted by output transmitter logic 312 over line 309.

FIG. 4A shows a flow diagram of a Preemptive Bandwidth Procedure A 400 in accordance with a specific embodiment of the present invention. For purposes of illustration, it is assumed that the Preemptive Bandwidth Procedure 400 of FIG. 4A is implemented in a system which has been configured to implement a ratio computation scheduling technique such as that described, for example, in FIG. 3A. However, it will be appreciated that preemptive bandwidth technique of the present invention may be implemented in a variety of conventional systems such as, for example, systems which utilize conventional scheduling QoS algorithms for scheduling flows of different priorities.

Initially, as shown at 402 of FIG. 4A, a number of parameters corresponding the each of the selected client flows are initialized. In the present example, it is assumed that the Preemptive Bandwidth Procedure 400 will be used to schedule data slots for 3 client processes, namely client process C1, client process C2, and preempt client process P1 (of FIG. 6A). However, it will be appreciated that any desired number of client processes or flows maybe scheduled using at least one scheduler which has been implemented in accordance with the technique of the present invention.

As shown at 402, the cell interval value (I_{I}) for each client flow is determined or retrieved. Additionally, the next calculated data cell interval value (N_{I}) for each client flow is set equal to zero. For example, a first variable N1 (corresponding to client flow C1) may be initialized and set equal to zero, a second variable N2 (corresponding to client flow C2) may be initialized and set equal to zero, and a third variable N3 (corresponding to preempt client flow P1) may be initialized and set equal to zero. According to a specific implementation, the parameter N_{I} may be defined as a fixed point fraction, as described in greater detail below. Additionally, at 402, the value T, which represents a total number of cell intervals which have elapsed since the start of the Preemptive Bandwidth Procedure, is set equal to zero. According to a specific implementation, the parameter T may be represented as an integer which keeps track of the total number of ATM cells which have been transmitted over line 309 since the start of the Preemptive Bandwidth Procedure 400.

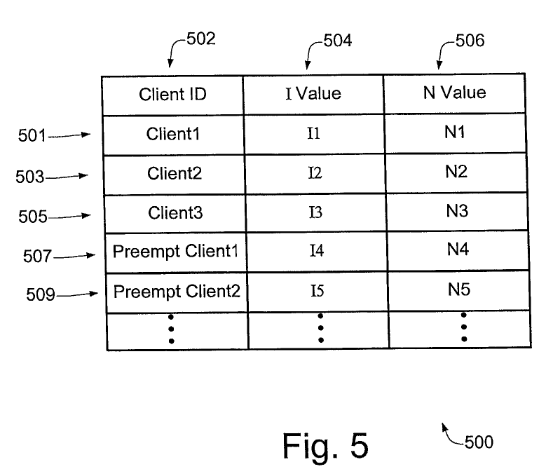

According to a specific embodiment of the present invention, at least some of the initialized variables of the Preemptive Bandwidth Procedure 400 may be stored in a table such as, for example, the Client Flow Table 500 of FIG. 5. As shown in FIG. 5, the Client Flow Table 500 may include a plurality of entries (e.g. 501, 503, 505, 507, 509, etc.) corresponding to different client flows, including both data client flows (e.g. 501, 503, 505) and/or preempt client flows (e.g. 507, 509). Each entry in Table 500 includes a first field 502 for identifying a specific client flow, a second field 504 for identifying a particular cell interval value (I_{I}) associated with that flow, and a third field 506 for identifying the next calculated data cell interval value (N_{I}) for that flow. In the present example, the Client Flow Table 500 may include the following values at the cell interval T=0:

| Client ID | I Value | N Value |
|---|---|---|
| C1 | 4.25 | 0 |
| C2 | 4.5 | 0 |
| P1 | 3.0 | 0 |

(T = 0)

After the initialization process has been completed, a determination is made (404) as to whether the output transmitter logic 312 is able to receive information from the scheduler(s) 332. According to a specific implementation, this determination may be made by checking to see whether the buffer for the output transmitter (e.g. 212, FIG. 2) is full. Assuming that the output transmitter buffer is not full, a determination is then made (408) as to whether there are any data parcels available to be sent to the output transmitter logic 312. In one implementation, such data parcels may include data parcels from data client flows (e.g. C1, C2), and/or data parcels from preempt client flows (e.g. P1).

According to a specific embodiment, as shown, for example, in FIG. 3A, scheduler 332 may include preemptive data parcel logic 334 which is configured to generate preempt data parcels. According to one implementation, the preemptive data parcel logic 334 may be configured to implement one or more virtual preempt client flows. In such an embodiment, the preemptive data parcel logic 334 may handle the generation and timing of the preempt data parcels which are to be transmitted over line 309. When the preemptive data parcel logic 334 determines that it is time to transmit a new preemptive data parcel, it may signal the scheduler 332, for example, by setting a status bit or flag or by queuing a preemptive data parcel in an appropriate data structure. Once the scheduler is aware that a new preemptive data parcel is ready to be sent over line 309, it may send the preempt data parcel to the output transmitter logic 312 for transmission over line 309.

According to a different implementation, the scheduler 332 may be configured to handle the timing and scheduling of one or more virtual preempt client flows. When the scheduler determines that it is time for a new preempt data parcel to be sent to the output transmitter logic, it may signal the preemptive data parcel logic 334 to generate a new preempt data parcel, which may then be sent to the output transmitter logic 312.

Assuming that at least one data parcel is available to be sent to the output transmitter logic 312, then a selected data parcel from an appropriate client flow (as determined by the scheduler) may be sent to the output transmitter logic 312 for transmission over line 309. Accordingly, as shown at 412 of FIG. 4A, a determination is made as to whether every integer value of N_{I} (for each active client flow) is greater than the current value of T. Since the current values of N1, N2, and N3 are each less than or equal to T (e.g. N1=N2=N3=T=0), the Preemptive Bandwidth Procedure continues at procedural block 414, wherein the client flow having the smallest I_{I} value is selected (414), while also giving priority to all preempt client flows. Thus, in the present example, this operation would result in the selecting of client P1 since preempt client flows (P1) have priority over data client flows (C1 and C2). In an alternate example where a second preempt client flow P2 is also initiated having an I_{I} value of I4=2.5, and an N_{I} value of N4=0, the P2 flow would be selected over the P1 flow since the value I4=2.5 (corresponding to preempt flow P2) is less than the value I3=3.0 (corresponding to preempt flow P1).

Returning to FIG. 4A, assuming that preempt flow P1 has been selected, a next data parcel for the selected flow (e.g. P1) is generated and transmitted by the scheduler to the output transmitter logic 312. According to a specific embodiment, the next data parcel for flow P1 corresponds to a preempt cell generated by preempt data parcel logic 334 (FIG. 3A). Thus, as shown in FIG. 6B, the cell which is transmitted by scheduler 332 at time T=0 corresponds to a preempt data parcel associated with client flow P1. In an alternate embodiment, as shown for example, in FIG. 3B, the preempt data parcel may be retrieved from an appropriate preempt client flow buffer (e.g. 361D) corresponding to preempt client flow P1.

After the next data parcel for the selected client flow has been sent to the output transmitter logic 312, the N_{I} value corresponding to the selected client flow (e.g. N3) is incremented (418) by its I_{I} value (e.g. I3). Thus, in the present example, the new value for N3 will be N3=0+I3=0+3=3. This updated value for N3 is then stored in an appropriate location at the Client Flow Table 500 (FIG. 5). Thereafter, the value T is incremented (420). According to the embodiment of FIG. 4A, the value T is incremented by one, resulting in a new value of T=1. Thereafter, flow of the Preemptive Bandwidth Procedure 400 continues at procedural block 404.

According to different embodiments of the present invention, a new data parcel will be sent from the scheduler 332 to the output transmitter logic 312 during each iteration of the Preemptive Bandwidth Procedure. In one implementation, the different types of cells which may be transmitted by the scheduler 332 to the output transmitter logic 312 include data parcels from process or application client flows, data parcels from preempt client flows (implemented either virtually or non-virtually), and/or “filler” data parcels. According to specific embodiments, a “filler” data parcel corresponds to a disposable data parcel which does not include meaningful data, and which is transmitted over a communication line for the purpose of providing a continuous bit stream between the egress and ingress ports of the communication line. Like preempt data parcels, “filler” data parcels are intended to be dropped by the physical layer at the receiving end of the communication line. For example, in one implementation, “filler” data parcels correspond to ATM idle cells.

In specific embodiments of the present invention, both “filler” data parcels and preempt data parcels may be implemented using ATM idle cells. However, one distinction to be appreciated between “filler” data parcels and preempt data parcels relates to the intended use of each type of data parcel. According to a specific embodiment, preempt data parcels are used to limit or restrict the effective usable bandwidth on a communication line, while “filler” data parcels are used during idle periods of transmission to ensure that a continuous bit stream is transmitted over the communication line.

Returning to FIG. 4A, at the beginning of the next iteration of the Preemptive Bandwidth Procedure 400, the value T is now T=1, and the values of the parameters in the Client Flow Table are as follows:

| Client ID | I Value | N Value |
|---|---|---|
| C1 | 4.25 | 0 |
| C2 | 4.5 | 0 |
| P1 | 3.0 | 3.0 |

(T = 1)

Assuming that data parcels are available to be sent to the output transmitter logic 312, the integer values of N1, N2 and N3 are compared to the value T in order to determine (412) whether each of these values exceeds the value of T. In the present example, the values N1=N2=0, which is less than the value of T. Therefore, the Preemptive Bandwidth Procedure continues at 414, wherein the client flow with the smallest I_{I} value is selected from a set of client flows whose integer values of N_{I} are less than or equal to T, giving priority to any preempt client flows. In the present example, this operation would result in the selecting (414) of client flow C1, since N3>T, and the value I1=4.25 (corresponding to Client C1) is less than the value I2=4.5 (corresponding to Client C2).

Accordingly, a next data parcel for the selected client process (e.g. C1) is retrieved and transmitted (416) by the scheduler to the output transmitter logic 312. According to a specific implementation, the next data to be transmitted (for selected client flow) may be obtained from the appropriate client flow buffer corresponding to the selected client flow. Thus, as shown in FIG. 6B, the cell which is transmitted by scheduler 332 at time T=1 corresponds to a data parcel associated with client flow C1. Thereafter, at 418, the value N1 is incremented to N1=4.25, and the value T is incremented to T=2.

According to a specific embodiment, if there is no data to be dequeued from the selected client flow buffer, a different client flow may be selected from the set of client flows satisfying the criteria integer [N_{I}] <=T, where the newly selected client has the next smallest I_{I} value.

At the beginning of the next iteration of the Preemptive Bandwidth Procedure, the value T is now T=2, and the other parameter values are as shown:

| Client ID | I Value | N Value |
|---|---|---|
| C1 | 4.25 | 4.25 |
| C2 | 4.5 | 0 |
| P1 | 3.0 | 3.0 |

(T = 2)

Since the integer values of N1, N2 and N3 are each not greater than T, the Preemptive Bandwidth Procedure will next select (414) client flow C2 for servicing. Accordingly, the scheduler may then dequeue a data parcel from the appropriate buffer associated with client C2, and send (416) the client C2 data parcel to the output transmitter logic 312 via line 307. This is illustrated in FIG. 6B, where a data parcel from the client C2 flow is scheduled or transmitted by the scheduler at time T=2. Thereafter, the value N2 will be incremented to N2=4.5, and the value T will be incremented to T=3.

At the beginning of the next iteration of the Preemptive Bandwidth Procedure, the value T is now T=3, and the other parameter values are as shown:

| Client ID | I Value | N Value |
|---|---|---|
| C1 | 4.25 | 4.25 |
| C2 | 4.5 | 4.5 |
| P1 | 3.0 | 3.0 |

(T = 3)

Since the integer values of N1, N2 and N3 are all not greater than T, the Preemptive Bandwidth Procedure will select (414) preempt client flow P1, and transmit a preempt data parcel to the output transmitter logic 312 via line 307. Accordingly, as shown in FIG. 6B, a preempt data parcel from preempt client P1 is scheduled at time T=3. Thereafter, the value N3 will be incremented to N3=6 and the value T will be incremented to T=4.

In the present example, continued iterations of the Preemptive Bandwidth Procedure will result in the scheduler scheduling and/or transmitting a stream of data parcels from the various client flows as shown at 602 of FIG. 6B.

It will be appreciated that, as shown in the example of FIG. 6B, a plurality of preempt data parcels are scheduled for transmission by the scheduler at specific time slots (e.g. T=0, 3, 6, 9, 12, etc.) in order to limit or restrict the effective usable bandwidth on line 309. According to a specific embodiment, the scheduling of preempt client flows will be given priority over any other type of flow. Thus, for example, as shown at T=9 and T=12 of FIG. 6B, the scheduler has been configured to give priority to the preempt client flow P1 when resolving scheduling conflicts between the preempt client flow P1 and any of the non-preempt client flows (e.g. C1, C2).

Additionally, as shown in the specific embodiment of FIG. 6B, a filler data parcel (represented as “1”) may be scheduled by the scheduler during idle times slots (e.g., T=7, T=11) when there are no client data parcels available for transmission. In one implementation, the filler data parcels correspond to idle ATM cells which are generated and sent by the scheduler to the output transmitter logic.

It will be appreciated that the connection shaping control technique of the present invention may be implemented in various types of conventional scheduling configurations. For example, according to one implementation, preemptive data parcel logic may be added to conventional scheduling entities in order to implement the connection shaping technique of the present invention.

FIG. 4B shows an alternate embodiment of a preemptive bandwidth procedure 470 which may be implemented in conjunction with conventional scheduling techniques. As shown in the embodiment of FIG. 4B, the scheduler may be configured to determine (476) whether a preempt data parcel is to be sent to the output transmitter logic before servicing any active data client flows. In one implementation, preemptive data parcel logic may be used to help make this determination. The preemptive data parcel logic may be integrated as part of the scheduler or schedulers (as shown, for example, in FIG. 3A), or may be implemented as a separate logical entity (as shown, for example, in FIG. 3C). In the embodiment of FIG. 3C, the scheduler(s) 392 may operate in conjunction with the preemptive data parcel logic 388 in order to implement the connection shaping control technique of the present invention, as described, for example, in FIG. 4B.

According to different embodiments, if it is determined that a preempt data parcel is to be sent to the output transmitter logic, the scheduler may either generate and send (485) a preempt data parcel to the output transmitter logic, or, alternatively, cause the preemptive data parcel logic 388 to generate and send the preempt data cell to the output transmitter logic. According to a specific embodiment, the scheduler may communicate with the preemptive data parcel logic in order to determine whether a preempt data parcel is to be sent or scheduled for the current time slot.

Assuming that no preempt data parcel is to be sent to the output transmitter logic, a determination is then made (478) as to whether there are any queued data parcels in any of the client flow buffers 391 to be sent to the output transmitter logic. Assuming that there is data to be sent, the scheduler may check once again to determine (480) whether a preempt data parcel should be scheduled or sent during the current timeslot. Assuming that no preempt data parcel is to be sent, the scheduler may select and send (482) a next appropriate client data parcel to the output transmitter circuitry in accordance with conventional QoS scheduling techniques.

It will be appreciated that the connection shaping technique of the present invention provides a number of additional advantages which are not realized by conventional connection shaping techniques. For example, according to one implementation, the connection shaping technique of the present invention provides for a uniform output flow from the output transmitter, which may include a uniform or predictable pattern of data/filler/preempt data parcels. Additionally, according to a specific embodiment, the scheduler of the present invention may perform its scheduling functions without requiring the use of an independent or separate clock source such as those required in conventional schedulers. The elimination of the clock source circuitry and accompanying logic results in a simplified scheduler design, and further results in a significant reduction in manufacturing costs.

Another difference between the connection shaping technique of the present invention and conventional techniques is that the scheduler of the present invention may be configured or designed to generate preempt and/or filler data parcels. In contrast, conventional schedulers typically do not provide such functionality. Additionally, according to a specific implementation, the clocking of the preempt data parcels may be implemented as a physical layer function, rather than a switching function. In this way, the switching function need not be burdened with network clocking and synchronous scheduling.

System Configurations

Referring now to FIG. 7, a network device 60 suitable for implementing the connection shaping techniques of the present invention includes a master central processing unit (CPU) 62A, interfaces 68, and various buses 67A, 67B, 67C, etc., among other components. According to a specific implementation, the CPU 62A may correspond to the eXpedite ASIC, manufactured by Mariner Networks, of Anaheim, Calif.

Network device 60 is capable of handling multiple interfaces, media and protocols. In a specific embodiment, network device 60 uses a combination of software and hardware components (e.g., FPGA logic, ASICs, etc.) to achieve high-bandwidth performance and throughput (e.g., greater than 6 Mbps), while additionally providing a high number of features generally unattainable with devices that are predominantly either software or hardware driven. In other embodiments, network device 60 can be implemented primarily in hardware, or be primarily software driven.

When acting under the control of appropriate software or firmware, CPU 62A may be responsible for implementing specific functions associated with the functions of a desired network device, for example a fiber optic switch or an edge router. In another example, when configured as a multi-interface, protocol and media network device, CPU 62A may be responsible for analyzing, encapsulating, or forwarding packets to appropriate network devices. Network device 60 can also include additional processors or CPUs, illustrated, for example, in FIG. 7 by CPU 62B and CPU 62C. In one implementation, CPU 62B can be a general purpose processor for handling network management, configuration of line cards, FPGA logic configurations, user interface configurations, etc. According to a specific implementation, the CPU 62B may correspond to a HELIUM Processor, manufactured by Virata Corp. of Santa Clara, Calif. In a different embodiment, such tasks may be handled by CPU62A, which preferably accomplishes all these functions under partial control of software (e.g., applications software and operating systems) and partial control of hardware.

CPU 62A may include one or more processors 63 such as the MIPS, Power PC or ARM processors. In an alternative embodiment, processor 63 is specially designed hardware (e.g., FPGA logic, ASIC) for controlling the operations of network device 60. In a specific embodiment, a memory 61 (such as non-persistent RAM and/or ROM) also forms part of CPU 62A. However, there are many different ways in which memory could be coupled to the system. Memory block 61 may be used for a variety of purposes such as, for example, caching and/or storing data, programming instructions, etc.

According to a specific embodiment, interfaces 68 may be implemented as interface cards, also referred to as line cards. Generally, the interfaces control the sending and receiving of data packets over the network and sometimes support other peripherals used with network device 60. Examples of the interfaces that may be provided are Ethernet interfaces, frame relay interfaces, cable interfaces, DSL interfaces, token ring interfaces, IP interfaces, etc. In addition, various ultra high-speed interfaces can be provided such as fast Ethernet interfaces, Gigabit Ethernet interfaces, ATM interfaces, HSSI interfaces, POS interfaces, FDDI interfaces and the like. Generally, these interfaces include ports appropriate for communication with appropriate media. In some cases, they also include an independent processor and, in some instances, volatile RAM. The independent processors may control communications intensive tasks such as data parcel switching, media control and management, framing, interworking, protocol conversion, data parsing, etc. By providing separate processors for communications-intensive tasks, these interfaces allow the main CPU 62A to efficiently perform routing computations, network diagnostics, security functions, etc. Alternatively, CPU 62A may be configured to perform at least a portion of the above-described functions such as, for example, data forwarding, communication protocol and format conversion, interworking, framing, data parsing, etc.

In a specific embodiment, network device 60 is configured to accommodate a plurality of line cards 70. At least a portion of the line cards are implemented as hot-swappable modules or ports. Other line cards may provide ports for communicating with the general-purpose processor, and may be configured to support standardized communication protocols such as, for example, Ethernet or DSL. Additionally, according to one implementation, at least a portion of the line cards may be configured to support Utopia and/or TDM connections.

Although the system shown in FIG. 7 illustrates one specific network device of the present invention, it is by no means the only network device architecture on which the present invention can be implemented. For example, an architecture having a single processor that handles communications as well as routing computations, etc., may be used. Further, other types of interfaces and media could also be used with the network device such as T1, E1, Ethernet or Frame Relay.

According to a specific embodiment, network device 60 may be configured to support a variety of different types of connections between the various components. For illustrative purposes, it will be assumed that CPU 62A is used as a primary reference component in device 60. However, it will be understood that the various connection types and configurations described below may be applied to any connection between any of the components described herein.

According to a specific implementation, CPU 62A supports connections to a plurality of Utopia lines. As commonly known to one having ordinary skill in the art, a Utopia connection is typically implemented as an 8-bit connection which supports standardized ATM protocol. In a specific embodiment, the CPU 62A may be connected to one or more line cards 70 via Utopia bus 67A and ports 69. In an alternate embodiment, the CPU 62A may be connected to one or more line cards 70 via point-to-point connections 51 and ports 69. The CPU 62A may also be connected to additional processors (e.g. 62B, 62C) via a bus or point-to-point connections (not shown). As described in greater detail below, the point-to-point connections may be configured to support a variety of communication protocols including, for example, Utopia, TDM, etc.

As shown in the embodiment of FIG. 7, CPU 62A may also be configured to support at least one bi-directional Time-Division Multiplexing (TDM) protocol connection to one or more line cards 70. Such a connection may be implemented using a TDM bus 67B, or may be implemented using a point-to-point link 51.

In a specific embodiment, CPU 62A may be configured to communicate with a daughter card (not shown) which can be used for functions such as voice processing, encryption, or other functions performed by line cards 70. According to a specific implementation, the communication link between the CPU 62A and the daughter card may be implemented using a bi-directional TDM connection and/or a Utopia connection.

According to a specific implementation, CPU 62B may also be configured to communicate with one or more line cards 70 via at least one type connection. For example, one connection may include a CPU interface that allows configuration data to be sent from CPU 62B to configuration registers on selected line cards 70. Another connection may include, for example, an EEPROM arrow interface to an EEPROM memory 72 residing on selected line cards 70.

Additionally, according to a specific embodiment, one or more CPUs may be connected to memories or memory modules 65. The memories or memory modules may be configured to store program instructions and application programming data for the network operations and other functions of the present invention described herein. The program instructions may specify an operating system and one or more applications, for example. Such memory or memories may also be configured to store configuration data for configuring system components, data structures, or other specific non-program information described herein.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM), Flash memory PROMS, random access memory (RAM), etc.

In a specific embodiment, CPU 62B may also be adapted to configure various system components including line cards 70 and/or memory or registers associated with CPU 62A. CPU 62B may also be configured to create and extinguish connections between network device 60 and external components. For example, the CPU 62B may be configured to function as a user interface via a console or a data port (e.g. Telnet). It can also perform connection and network management for various protocols such as Simple Network Management Protocol (SNMP).

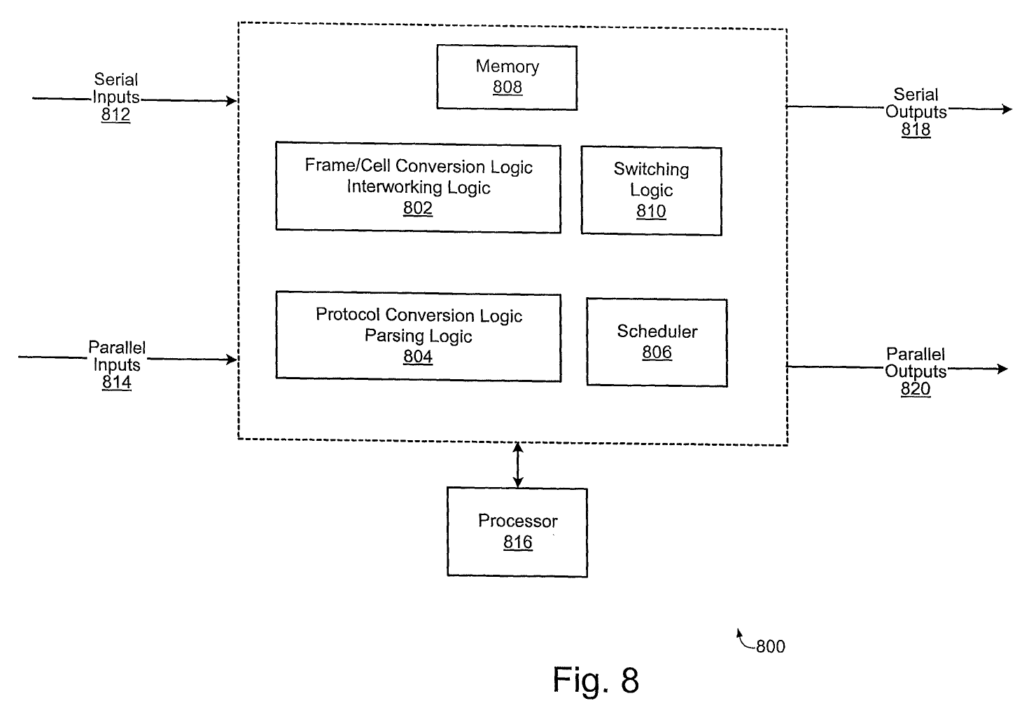

FIG. 8 shows a block diagram of various inputs/outputs, components and connections of a system 800 which may be used for implementing various aspects of the present invention. According to a specific embodiment, system 800 may correspond to CPU 62A of FIG. 7.

As shown in the embodiment of FIG. 8, system 800 includes cell switching logic 810 which operates in conjunction with a scheduler 806. In one implementation, cell switching logic 810 is configured as an ATM cell switch. In other implementations, switching logic block 810 may be configured as a packet switch, a frame relay switch, etc.

Scheduler 806 provides quality of service (QoS) shaping for switching logic 810. For example, scheduler 806 may be configured to shape the output from system 800 by controlling the rate at which data leaves an output port (measured on a per flow/connection basis). Additionally, scheduler 806 may also be configured to perform policing functions on input data. Additional details relating to switching logic 810 and scheduler 806 are described below.

As shown in the embodiment of FIG. 8, system 800 includes logical components for performing desired format and protocol conversion of data from one type of communication protocol to another type of communication protocol. For example, the system 800 may be configured to perform conversion of frame relay frames to ATM cells and vice-versa. Such conversions are typically referred to as interworking. In one implementation, the interworking operations may be performed by Frame/Cell Conversion Logic 802 in system 800 using standardized conversion techniques as described, for example, in the following reference documents, each of which is incorporated herein by reference in its entirety for all purposes

ATM Forum

(1) “B-ICI Integrated Specification 2.0”, af-bici-0013.003, December 1995

(2) “User Network Interface (UNI) Specification 3.1”, af-uni-0010.002, September 1994

(3) “Utopia Level 2, v1.0”, af-phy-0039.000, June 1995

(4) “A Cell-based Transmission Convergence Sublayer for Clear Channel Interfaces”, af-phy-0043.000, November 1995

Frame Relay Forum

(5) “User-To-Network Implementation Agreement (UNI)”, FRF.1.2, July 2000

(6) “Frame Relay/ATM PVC Service Interworking Implementation Agreement”, FRF.5, April 1995

(7) “Frame Relay/ATM PVC Service Interworking Implementation Agreement”, FRF.8.1, December 1994

ITU-T

(8) “B-ISDN User Network Interface—Physical Layer Interface Specification”, Recommendation 1.432, March 1993

(9) “B-ISDN ATM Layer Specification”, Recommendation 1.361, March 1993

As shown in the embodiment of FIG. 8, system 800 may be configured to include multiple serial input ports 812 and multiple parallel input ports 814. In a specific embodiment, a serial port may be configured as an 8-bit TDM port for receiving data corresponding to a variety of different formats such as, for example, Frame Relay, raw TDM (e.g., HDLC, digitized voice), ATM, etc. In a specific embodiment, a parallel port, also referred to as a Utopia port, is configured to receive ATM data. In other embodiments, parallel ports 814 may be configured to receive data in other formats and/or protocols. For example, in a specific embodiment, ports 814 may be configured as Utopia ports which are able to receive data over comparatively high-speed interfaces, such as, for example, E3 (35 megabits/sec.) and DS3 (45 megabits/sec.).

According to a specific embodiment, incoming data arriving via one or more of the serial ports is initially processed by protocol conversion and parsing logic 804. As data is received at logic block 804, the data is demultiplexed, for example, by a TDM multiplexer (not shown). The TDM multiplexer examines the frame pulse, clock, and data, and then parses the incoming data bits into bytes and/or channels within a frame or cell. More specifically, the bits are counted to partition octets to determine where bytes and frames/cells start and end. This may be done for one or multiple incoming TDM datapaths. In a specific embodiment, the incoming data is converted and stored as sequence of bits which also include channel number and port number identifiers. In a specific embodiment, the storage device may correspond to memory 808, which may be configured, for example, as a one-stack FIFO.

According to different embodiments, data from the memory 808 is then classified, for example, as either ATM or Frame Relay data. In other preferred embodiments, other types of data formats and interfaces may be supported. Data from memory 808 may then be directed to other components, based on instructions from processor 816 and/or on the intelligence of the receiving components. In one implementation, logic in processor 816 may identify the protocol associated with a particular data parcel, and assist in directing the memory 808 in handing off the data parcel to frame/cell conversion logic 802.

In the embodiment of FIG. 8, frame relay/ATM interworking may be performed by interworking logic 802 which examines the content of a data frame. As commonly known to one having ordinary skill in the art of network protocol, interworking involves converting address header and other information in from one type of format to another. In a specific embodiment, interworking logic 802 may perform conversion of frames (e.g. frame relay, TDM) to ATM cells and vice versa. More specifically, logic 802 may convert HDLC frames to ATM Adaptation Layer 5 (AAL 5) protocol data units (PDUs) and vice versa. Interworking logic 802 also performs bit manipulations on the frames/cells as needed. In some instances, serial input data received at logic 802 may not have a format (e.g. streaming video), or may have a particular format (e.g., frame relay header and frame relay data).

In at least one embodiment, the frame/cell conversion logic 802 may include additional logic for performing channel grooming. In one implementation, such additional logic may include an HDLC framer configured to perform frame delineation and bit stuffing. As commonly known to one having ordinary skill in the art, channel grooming involves organizing data from different channels in to specific, logical contiguous flows. Bit stuffing typically involves the addition or removal of bits to match a particular pattern.

According to at least one embodiment, system 800 may also be configured to receive as input ATM cells via, for example, one or more Utopia input ports. In one implementation, the protocol conversion and parsing logic 804 is configured to parse incoming ATM data cells (in a manner similar to that of non-ATM data) using a Utopia multiplexer. Certain information from the parser, namely a port number, ATM data and data position number (e.g., start-of-cell bit, ATM device number) is passed to a FIFO or other memory storage 808. The cell data stored in memory 808 may then be processed for channel grooming.

In specific embodiments, the frame/cell conversion logic 802 may also include a cell processor (not shown) configured to process various data parcels, including, for example, ATM cells and/or frame relay frames. The cell processor may also perform cell delineation and other functions similar to channel grooming functions performed for TDM frames. As commonly known in the field of ATM data transfer, a standard ATM cell contains 424 bits, of which 32 bits are used for the ATM cell header, eight bits are used for error correction, and 384 bits are used for the payload.

Once the incoming data has been processed and, if necessary, converted to ATM cells, the cells are input to switching logic 810. In a specific embodiment, switching logic 810 corresponds to a cell switch which is configured to route the input ATM data to an appropriate destination based on the ATM cell header (which may include a unique identifier, a port number and a device number or channel number, if input originally as serial data).

According to a specific embodiment, the switching logic 810 operates in conjunction with a scheduler 806. Scheduler 806 uses information from processor 816 which provides specific scheduling instructions and other information to be used by the scheduler for generating one or more output data streams. The processor 816 may perform these scheduling functions for each data stream independently. For example, the processor 816 may include a series of internal registers which are used as an information repository for specific scheduling instructions such as, expected addressing, channel index, QoS, routing, protocol identification, buffer management, interworking, network management statistics, etc.

Scheduler 806 may also be configured to synchronize output data from switching logic 810 to the various output ports, for example, to prevent overbooking of output ports. Additionally, the processor 816 may also manage memory 808 access requests from various system components such as those shown, for example, in FIGS. 7 and 8 of the drawings. In a specific embodiment, a memory arbiter (not shown) operating in conjunction with memory 808 controls routing of memory data to and from requesting clients using information stored in processor 816. In a specific embodiment, memory 808 includes DRAM, and memory arbiter is configured to handle the timing and execution of data access operations requested by various system components such as those shown, for example, in FIGS. 7 and 8 of the drawings.

Once cells are processed by switching logic 810, they are processed in a reverse manner, if necessary, by frame/cell conversion logic 802 and protocol conversion logic 804 before being released by system 800 via serial or TDM output ports 818 and/or parallel or Utopia output ports 820. According to a specific implementation, ATM cells are converted back to frames if the data was initially received as frames, whereas data received in ATM cell format may bypass the reverse processing of frame/cell conversion logic 802.

For purposes of illustration, the techniques of the present invention have been described with reference to their applications in ATM networks. However, it will be appreciated that the connection shaping technique of the present invention may be adapted to be used in a variety of different data networks utilizing different protocols such as, for example, packet-switched networks, frame relay networks, ATM networks, etc. For example, in frame relay environments, the scheduling logic at the client entity may be configured to generate and transmit “filler” frames and/or preempt frames to the physical layer for transmission over the frame relay network. According to specific implementations, “filler” frames and/or preempt frames may be generated by inserting specific patterns of flag bytes into the output communication stream, for example, in accordance with the FRF.1.2 protocol. Such flag bytes are used to indicate that a particular portion of continuous bits (e.g. forming a frame) do not contain meaningful data, and therefore may be discarded at the physical layer of the entity receiving the communication stream.

Additionally, according to a specific embodiments, preempt data parcels may also be transmitted over the communication line from the service provider end to thereby limit the effective usable bandwidth on the communication line.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

1. A method for controlling bandwidth resources used on a communication line in a data network, wherein a first end of the communication line is connected to a first entity, and a second end of the communication line is connected to a second entity, the method comprising:
determining a first desired portion of bandwidth on the communication line to be prevented from being used by the first entity for transmitting data parcels which include meaningful data; and
transmitting preempt data parcels over the communication line to thereby cause the first desired portion of bandwidth on the communication line to be prevented from being used by the first entity for transmitting data parcels which include meaningful data;
wherein the preempt data parcels correspond to disposable data parcels which include non-meaningful data.

2. The method of claim 1 wherein further comprising transmitting the preempt data parcels as a continuous bit stream.

3. The method of claim 1 wherein the preempt data parcels correspond to data parcels associated with a constant bit rate communication flow.

4. The method of claim 1 wherein the preempt data parcels have a relative higher priority than non-preempt data parcels transmitted over the communication line.

5. The method of claim 1 further comprising using a second portion of bandwidth on the communication line to transmit client data parcels from at least one client flow;
the second portion bandwidth being different than said first portion of bandwidth.

6. The method of claim 1 further comprising:
scheduling a client data parcel for transmission over the communication line; and
scheduling a preempt data parcel for transmission over the communication line;
wherein the scheduling of the preempt data parcel takes priority over the scheduling of the client data parcel for a given time slot.

7. The method of claim 1 further comprising:
determining a second desired portion of bandwidth on the communication line to be used by the first entity for transmitting data parcels which include meaningful data.

8. The method of claim 1 wherein the first entity corresponds to a customer entity; and
wherein the second entity corresponds to a service provider entity.

9. The method of claim wherein the first end corresponds to an egress side of the communication line; and
wherein the second end corresponds to an ingress side of the communication line.

10. The method of claim 1 further comprising generating the preempt data parcels at the first entity.

11. The method of claim 10 wherein the preempt data parcels are generated at a scheduler residing at the first entity.

12. The method of claim 10 wherein the preempt data parcels are generated in response to a signal initiated by a scheduler residing at the first entity.

13. The method of claim 10 wherein said scheduling is performed by a scheduler, said scheduler being devoid of a local clock source.

14. The method of claim 10 wherein the scheduling operations are performed by a scheduler; and
wherein the scheduling operations are not based on an internal time reference.

15. The method of claim 1 further comprising controlling an effective usable bandwidth by the first entity for transmitting over the communication line data parcels which include meaningful data by transmitting preempt data parcels over the communication line.

16. The method of claim wherein the corresponds to a connection shaping technique implemented at egress port of a communication link.

17. The method of claim wherein the corresponds to a connection shaping technique implemented at a client entity.

18. The method of claim 17 wherein the connection shaping technique does not use a clock source to throttle an output bit stream transmitted over the communication line.

19. The method of claim 1 further comprising:
receiving, at the second entity, a preempt data parcel at an ingress port of the communication line, the preempt data parcel including non-meaningful data;
receiving, at the second entity, a non-preempt data parcel at the ingress port of the communication line, the non-preempt data parcel including meaningful data;
disposing the preempt data parcel; and
forwarding the non-preempt data parcel to a final destination address.

20. The method of claim 1 wherein said determining includes determining an appropriate ratio of preempt data parcels to be inserted into an output bit stream transmitted over the communication line to thereby limit an effective usable bandwidth of the communication line to be used by the first entity for transmitting data parcels which include meaningful data.

21. The method of claim 1 further comprising continuously transmitting a continuous stream bits over the first communication line during normal operation of the communication line.

22. The method of claim 1 wherein the first communication line corresponds to a communication line utilizing an ATM protocol; and
wherein the preempt data parcels correspond to ATM idle cells.

23. The method of claim 1 wherein the first communication line corresponds to a communication line utilizing a frame relay protocol; and
wherein the preempt data parcels correspond to disposable frames which include predefined flag bytes.

24. A method for implementing connection shaping at one end of a communication line in a data network, wherein a first end of the communication line is connected to a first entity, and a second end of the communication line is connected to a second entity, the method comprising:
determining a first desired portion of bandwidth on the communication line to be prevented from being used by the first entity for transmitting data parcels which include meaningful data; and
scheduling preempt data parcels to be included in an output stream provided to physical layer logic for transmission over the first communication line to thereby cause the first desired portion of bandwidth on the communication line to be prevented from being used by the first entity for transmitting data parcels which include meaningful data;
wherein the preempt data parcels correspond to disposable data parcels which include non-meaningful data.

25. The method of claim 24 further comprising:
scheduling selected client data parcels, associated with at least one client flow, to be included in the output stream provided to physical layer logic for transmission over the first communication line;
determining an appropriate ratio of preempt data parcels to be inserted into an output bit stream transmitted over the communication line to thereby limit an effective usable bandwidth of the communication line to be used by the first entity for transmitting data parcels which include meaningful data; and
generating the output stream;
wherein the output stream includes client data parcels and preempt data parcels.

26. The method of claim 24 wherein the output stream includes a uniform pattern of client data parcels and preempt data parcels.

27. The method of claim 24 wherein the output stream includes a uniform pattern of client data parcels and preempt data parcels; and
wherein the method further comprises repeating the uniform pattern of client data parcels and preempt data parcels on a periodic basis.

28. The method of claim 25 wherein further comprising transmitting the output stream over the communication line.

29. The method of claim 24 wherein the preempt data parcels have a relative higher priority than non-preempt data parcels transmitted over the communication line.

30. The method of claim 25 further comprising using a second portion of bandwidth on the communication line to transmit the client data parcels;
the second portion bandwidth being different than said first portion of bandwidth.

31. The method of claim 24 wherein the scheduling of the preempt data parcel takes priority over the scheduling of the client data parcel for a given time slot.

32. The method of claim 24 wherein the first entity corresponds to a customer entity; and
wherein the second entity corresponds to a service provider entity.

33. The method of claim wherein the first end corresponds to an egress side of the communication line; and
wherein the second end corresponds to an ingress side of the communication line.

34. The method of claim 24 further comprising generating the preempt data parcels at the first entity.

35. The method of claim 24 wherein the preempt data parcels are generated at a scheduler residing at the first entity.

36. The method of claim 24 wherein the preempt data parcels are generated in response to a signal initiated by a scheduler residing at the first entity.

37. The method of claim 24 wherein said scheduling is performed by a scheduler, said scheduler being devoid of a local clock source.

38. The method of claim 34 wherein the scheduling operations are not based on an internal time reference.

39. The method of claim 24 further comprising controlling an effective usable bandwidth by the first entity for transmitting over the communication line data parcels which include meaningful data by transmitting preempt data parcels over the communication line.

40. The method of claim 24 wherein the connection shaping technique does not use a clock source to throttle an output bit stream transmitted over the communication line.

41. The method of claim 24 further comprising:
receiving, at the second entity, a preempt data parcel at an ingress port of the communication line, the preempt data parcel including non-meaningful data;
receiving, at the second entity, a non-preempt data parcel at the ingress port of the communication line, the non-preempt data parcel including meaningful data;
disposing the preempt data parcel; and
forwarding the non-preempt data parcel to a final destination address.

42. The method of claim 24 further comprising continuously transmitting a continuous stream bits over the first communication line during normal operation of the communication line.

43. The method of claim 24 wherein the first communication line corresponds to a communication line utilizing an ATM protocol; and
wherein the preempt data parcels correspond to ATM idle cells.

44. The method of claim 24 wherein the first communication line corresponds to a communication line utilizing a frame relay protocol; and
wherein the preempt data parcels correspond to disposable frames which include predefined flag bytes.

45. A system for controlling bandwidth resources used on a communication line in a data network, wherein a first end of the communication line is connected to a first entity, and a second end of the communication line is connected to a second entity, the system comprising:
at least one processor;
at least one interface configured or designed to provide a communication link to at least one other network device in the data network; and
memory;
the system being configured or designed to determine a first desired portion of bandwidth on the communication line to be prevented from being used by the first entity for transmit data parcels which include meaningful data; and
the system being further configured or designed to transmit preempt data parcels over the communication line to thereby cause the first desired portion of bandwidth on the communication line to be prevented from being used by the first entity for transmit data parcels which include meaningful data;
wherein the preempt data parcels correspond to disposable data parcels which include non-meaningful data.

46. The system of claim 45 being further configured or designed to transmit the preempt data parcels as a continuous bit stream.

47. The system of claim 45 wherein the preempt data parcels correspond to data parcels associated with a constant bit rate communication flow.

48. The system of claim 45 wherein the preempt data parcels have a relative higher priority than non-preempt data parcels transmitted over the communication line.

49. The system of claim 45 being further configured or designed to use a second portion of bandwidth on the communication line to transmit client data parcels from at least one client flow;
the second portion bandwidth being different than said first portion of bandwidth.

50. The system of claim 45 being further configured or designed to schedule a client data parcel for transmission over the communication line; and
the system being further configured or designed to schedule a preempt data parcel for transmission over the communication line;
wherein the schedule of the preempt data parcel takes priority over the schedule of the client data parcel for a given time slot.

51. The system of claim 45 being further configured or designed to determine a second desired portion of bandwidth on the communication line to be used by the first entity for transmitting data parcels which include meaningful data.

52. The system of claim 45 wherein the first entity corresponds to a customer entity; and
wherein the second entity corresponds to a service provider entity.

53. The system of claim wherein the first end corresponds to an egress side of the communication line; and
wherein the second end corresponds to an ingress side of the communication line.

54. The system of claim 45 being further configured or designed to generate the preempt data parcels at the first entity.

55. The system of claim 54 wherein the preempt data parcels are generated at a scheduler residing at the first entity.

56. The system of claim 54 wherein the preempt data parcels are generated in response to a signal initiated by a scheduler residing at the first entity.

57. The system of claim 54 wherein said schedule is performed by a scheduler, said scheduler being devoid of a local clock source.

58. The system of claim 54 wherein the schedule operations are performed by a scheduler; and
wherein the schedule operations are not based on an internal time reference.

59. The system of claim 45 being further configured or designed to control an effective usable bandwidth by the first entity for transmitting over the communication line data parcels which include meaningful data by transmit preempt data parcels over the communication line.

60. The system of claim 45 being further configured or designed to not use a clock source to throttle an output bit stream transmitted over the communication line.

61. The system of claim 45 fur being further configured or designed to receive a preempt data parcel at an ingress port of the communication line, the preempt data parcel including non-meaningful data;
the system being further configured or designed to receive a non-preempt data parcel at the ingress port of the communication line, the non-preempt data parcel including meaningful data;
the system being further configured or designed to dispose of the preempt data parcel; and
the system being further configured or designed to forward the non-preempt data parcel to a final destination address.

62. The system of claim 45 being further configured or designed to determine an appropriate ratio of preempt data parcels to be inserted into an output bit stream transmitted over the communication line to thereby limit an effective usable bandwidth of the communication line to be used by the first entity for transmitting data parcels which include meaningful data.

63. The system of claim 45 being further configured or designed to transmit a continuous stream bits over the first communication line during normal operation of the communication line.

64. The system of claim 45 wherein the first communication line corresponds to a communication line utilizing an ATM protocol; and
wherein the preempt data parcels correspond to ATM idle cells.

65. The system of claim 45 wherein the first communication line corresponds to a communication line utilizing a frame relay protocol; and
wherein the preempt data parcels correspond to disposable frames which include predefined flag bytes.

66. A system for implementing connection shaping at one end of a communication line in a data network, wherein a first end of the communication line is connected to a first entity, and a second end of the communication line is connected to a second entity, the system comprising:
a scheduler adapted to determine a first desired portion of bandwidth on the communication line to be prevented from being used by the first entity for transmit data parcels which include meaningful data; and
the scheduler being configured or designed to schedule preempt data parcels to be included in an output stream provided to physical layer logic for transmission over the first communication line to thereby cause the first desired portion of bandwidth on the communication line to be prevented from being used by the first entity for transmit data parcels which include meaningful data;
wherein the preempt data parcels correspond to disposable data parcels which include non-meaningful data.

67. The system of claim 66 being further configured or designed to schedule selected client data parcels, associated with at least one client flow, to be included in the output stream provided to physical layer logic for transmission over the first communication line;
the scheduler being further configured or designed to determine an appropriate ratio of preempt data parcels to be inserted into an output bit stream transmitted over the communication line to thereby limit an effective usable bandwidth of the communication line to be used by the first entity for transmitting data parcels which include meaningful data; and
the scheduler being further configured or designed to generate the output stream;
wherein the output stream includes client data parcels and preempt data parcels.

68. The system of claim 66 wherein the output stream includes a uniform pattern of client data parcels and preempt data parcels.

69. The system of claim 66 wherein the output stream includes a uniform pattern of client data parcels and preempt data parcels; and
wherein the system further comprises repeating the uniform pattern of client data parcels and preempt data parcels on a periodic basis.

70. The system of claim 67 wherein the system is further configured or designed to transmit the output stream over the communication line.

71. The system of claim 66 wherein the preempt data parcels have a relative higher priority than non-preempt data parcels transmitted over the communication line.

72. The system of claim 67 being further configured or designed to use a second portion of bandwidth on the communication line to transmit the client data parcels;
the second portion bandwidth being different than said first portion of bandwidth.

73. The system of claim 66 wherein the scheduling of the preempt data parcel takes priority over the schedule of the client data parcel for a given time slot.

74. The system of claim 66 wherein the first entity corresponds to a customer entity; and
wherein the second entity corresponds to a service provider entity.

75. The system of claim wherein the first end corresponds to an egress side of the communication line; and
wherein the second end corresponds to an ingress side of the communication line.

76. The system of claim 66 being further configured or designed to generate the preempt data parcels at the first entity.

77. The system of claim 66 wherein the preempt data parcels are generated at a scheduler residing at the first entity.

78. The system of claim 66 wherein the preempt data parcels are generated in response to a signal initiated by a scheduler residing at the first entity.

79. The system of claim 66 wherein said scheduling is performed by a scheduler, said scheduler being devoid of a local clock source.

80. The system of claim 76 wherein the scheduling operations are not based on an internal time reference.

81. The system of claim 66 being further configured or designed to control an effective usable bandwidth by the first entity for transmitting over the communication line data parcels which include meaningful data by transmitting preempt data parcels over the communication line.

82. The system of claim 66 being further configured or designed to not use a clock source to throttle an output bit stream transmitted over the communication line.

83. The system of claim 66 to receive a preempt data parcel at an ingress port of the communication line, the preempt data parcel including non-meaningful data;
the system being further configured or designed to receive a non-preempt data parcel at the ingress port of the communication line, the non-preempt data parcel including meaningful data;
the system being further configured or designed to dispose of the preempt data parcel; and
the system being further configured or designed to forward the non-preempt data parcel to a final destination address.

84. The system of claim 66 being further configured or designed to continuously transmit a continuous stream bits over the first communication line during normal operation of the communication line.

85. The system of claim 66 wherein the first communication line corresponds to a communication line utilizing an ATM protocol; and
wherein the preempt data parcels correspond to ATM idle cells.

86. The system of claim 66 wherein the first communication line corresponds to a communication line utilizing a frame relay protocol; and
wherein the preempt data parcels correspond to disposable frames which include predefined flag bytes.

87. A computer program product for controlling bandwidth resources used on a communication line in a data network, wherein a first end of the communication line is connected to a first entity, and a second end of the communication line is connected to a second entity, the computer program product comprising:
a computer usable medium having computer readable code embodied therein, the computer readable code comprising:
computer code for determining a first desired portion of bandwidth on the communication line to be prevented from being used by the first entity for transmitting data parcels which include meaningful data; and
computer code for transmitting preempt data parcels over the communication line to thereby cause the first desired portion of bandwidth on the communication line to be prevented from being used by the first entity for transmitting data parcels which include meaningful data;
wherein the preempt data parcels correspond to disposable data parcels which include non-meaningful data.

88. A computer program product for implementing connection shaping at one end of a communication line in a data network, wherein a first end of the communication line is connected to a first entity, and a second end of the communication line is connected to a second entity, the computer program product comprising:
a computer usable medium having computer readable code embodied therein, the computer readable code comprising:
computer code for determining a first desired portion of bandwidth on the communication line to be prevented from being used by the first entity for transmitting data parcels which include meaningful data; and
computer code for scheduling preempt data parcels to be included in an output stream provided to physical layer logic for transmission over the first communication line to thereby cause the first desired portion of bandwidth on the communication line to be prevented from being used by the first entity for transmitting data parcels which include meaningful data;
wherein the preempt data parcels correspond to disposable data parcels which include non-meaningful data.

89. The computer program product of claim 88 further comprising:
computer code for scheduling selected client data parcels, associated with at least one client flow, to be included in the output stream provided to physical layer logic for transmission over the first communication line;
computer code for determining an appropriate ratio of preempt data parcels to be inserted into an output bit stream transmitted over the communication line to thereby limit an effective usable bandwidth of the communication line to be used by the first entity for transmitting data parcels which include meaningful data; and
computer code for generating the output stream;
wherein the output stream includes client data parcels and preempt data parcels.

90. A system for controlling bandwidth resources used on a communication line in a data network, wherein a first end of the communication line is connected to a first entity, and a second end of the communication line is connected to a second entity, the system comprising:
means for determining a first desired portion of bandwidth on the communication line to be prevented from being used by the first entity for transmitting data parcels which include meaningful data; and
means for scheduling preempt data parcels to be included in an output stream provided to physical layer logic for transmission over the first communication line to thereby cause the first desired portion of bandwidth on the communication line to be prevented from being used by the first entity for transmitting data parcels which include meaningful data;
wherein the preempt data parcels correspond to disposable data parcels which include non-meaningful data.

91. The system of claim 90 further comprising:
means for scheduling selected client data parcels, associated with at least one client flow, to be included in the output stream provided to physical layer logic for transmission over the first communication line;
means for determining an appropriate ratio of preempt data parcels to be inserted into an output bit stream transmitted over the communication line to thereby limit an effective usable bandwidth of the communication line to be used by the first entity for transmitting data parcels which include meaningful data; and
means for generating the output stream;
wherein the output stream includes client data parcels and preempt data parcels.
